(19) United States
(12) Patent Application Publication
(10) Pub. No.: US 2017/0050531 A1
(43) Pub. Date: Feb. 23, 2017

(54) METHOD AND DEVICE FOR MONITORING THE ELECTRICAL BATTERY OF A VEHICLE

(71) Applicant: RENAULT s.a.s., Boulogne Billancourt (FR)

(72) Inventors: Sophie GENIN-DEMURE, Antony (FR); Gerard SAINT-LEGER, Versailles (FR)

(73) Assignee: RENAULT S.A.S, Boulogne Billancourt (FR)

(21) Appl. No.: 15/307,250

(22) PCT Filed: Mar. 25, 2015
(86) PCT No.: PCT/FR2015/050749

§ 371 Date: Oct. 27, 2016

(30) Foreign Application Priority Data
Apr. 30, 2014 (FR) 1453956

(51) Int. Cl. B60L 11/18; H02J 7/00

(52) U.S. Cl. CPC B60L 11/1861; H02J 7/0021; B60L 11/1822; B60L 11/1838; H02J 2007/0096

(57) ABSTRACT

A method that monitors an electrical battery of a vehicle includes, consecutively, measuring a state-of-charge of the electrical battery at predetermined intervals, comparing the measured values of the state-of-charge of the electrical battery with a first predetermined threshold, and comparing a number of the measured values below the predetermined threshold to a predetermined number, in order to decide whether to replace or recharge the electrical battery, in order to avoid or remedy an immobilization of the vehicle.

The invention relates to a method for monitoring an electrical battery of a vehicle.

The invention also relates to a device for monitoring an electrical battery of a vehicle.

The invention is particularly useful in providing a mechanic or operator with decision-making assistance when faced with a vehicle that does not start and in informing a driver or a vehicle user of an abnormality relating to the electrical battery of the vehicle.

The invention is also particularly useful for sending a mechanic, an operator, a user or a vehicle driver, a warning, an alert or an indication relating to the state of the electrical battery used to start the vehicle.

Should a breakdown occur immobilizing a vehicle, a mechanic or an operator may be faced with numerous cases of vehicle immobilization.

Should a breakdown occur preventing the immediate start-up of the vehicle, the operator or the mechanic can thus not easily determine if the existing battery must be replaced with a new battery, or if the existing battery only needs to be recharged if it has been subjected to a deep discharge.

Generally speaking, in the absence of sufficient information, the operator or the mechanic is led to replace the existing battery with a new battery, so as allow the vehicle to be started rapidly and to avoid an immobilization in the near future. However, it has been found that, in three-quarters of the cases, the batteries had simply been subjected to a deep discharge that does not justify their replacement.

Furthermore, in the case of stopped vehicles, the driver or the user may forget to switch off the headlights or another electricity consuming device, which leads to the progressive discharge of the electrical battery, even to an immobilization of the vehicle preventing the subsequent start-up of the vehicle.

Also, in the case of a sleeping vehicle which should not consume electric current, a fault inside the vehicle may lead to an undesirable discharge of the electrical battery.

A need has therefore emerged to monitor the electrical batteries of vehicles so as to avoid unnecessary replacements with new batteries, and to allow a user or a driver to correct an electrical battery discharge condition that could lend to an immobilization of the vehicle.

A first purpose of the invention is to overcome the drawbacks of the prior art. by proposing a new method for monitoring an electrical battery of a vehicle making it possible to avoid or remedy the immobilization of the vehicle.

Another purpose of the invention is to provide a new device for monitoring an electrical battery of a vehicle making it possible to avoid or remedy the immobilization of the vehicle.

The invention relates to a method for monitoring an electrical battery of a vehicle, comprising consecutive steps of measuring the state-of-charge of the battery at predetermined intervals, characterized in that the method further comprises steps of comparing the measured values of the state-of-charge of the battery with a predetermined threshold and steps of comparing the number of measured values below said predetermined threshold to a predetermined number, to decide whether to replace or recharge the electrical battery, in order to avoid or remedy an immobilization of the vehicle.

According to other alternative features of the invention:
the method comprises a step of determining the status of the vehicle to determine if the vehicle is electrically asleep or not.
the method comprises a step of sending an alert, for example an e-mail, a text message or any other type of warning message to a driver or user of the vehicle.
the method comprises a step of determining whether a diagnostic can be performed on the electrical battery of the vehicle using a diagnostic set.
the method comprises a step of determining and of testing the last open circuit voltage OCV values of the electrical battery to know whether or not the last open circuit voltage values are significantly higher than zero volts.
the method comprises a step of controlling the date of the last recordings of the state-of-charge of the electrical battery under no load, in order to determine if the electrical battery should be charged or if it should be replaced with a new battery.
the method comprises a step of controlling the number of steps in which the recorded measured values of the state-of-charge of the electrical battery are less than a predetermined number, in order to decide if the electrical battery should be charged or if it should be replaced with a new battery.

The invention also relates to a device for monitoring an electrical battery of a vehicle, comprising means for consecutively measuring the state-of-charge of the battery at predetermined intervals, characterized by means for comparing the measured values of the state-of-charge of the battery with a predetermined threshold and by means for comparing the number of measured values below said predetermined threshold to a predetermined number, in order to decide whether to replace or recharge the electrical battery, in order to avoid or remedy an immobilization of the vehicle.

According to other alternative features of the invention:
the device comprises a CAN communication bus able to be connected to a diagnostic set and to a telecommunication control unit, said telecommunication control unit being able to issue an alert to a receiver of a driver or vehicle user.
the device comprises a LIN communication bus connecting an electrical power management computer to an electrical battery of a vehicle.

The invention will be further understood from the description that follows, given by way of non-limning example, in reference to the accompanying drawings in which:

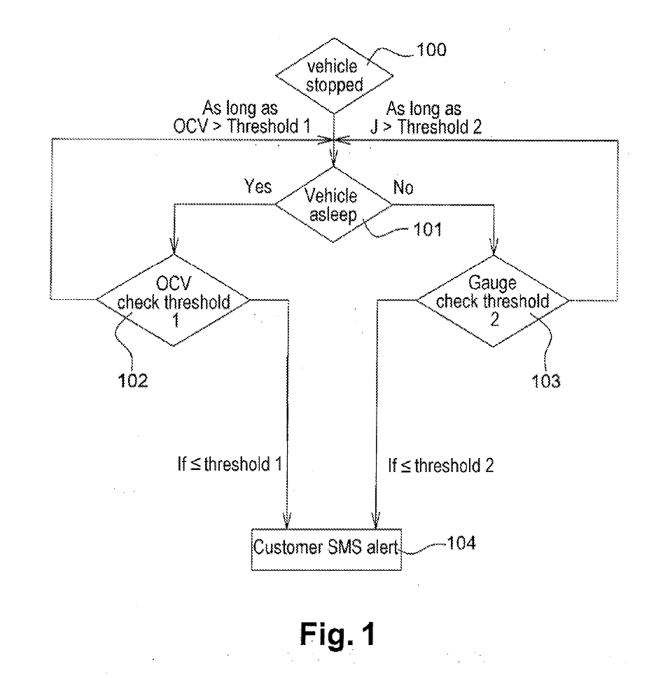

FIG. 1 schematically represents a flowchart of a method for monitoring an electrical battery of a vehicle.

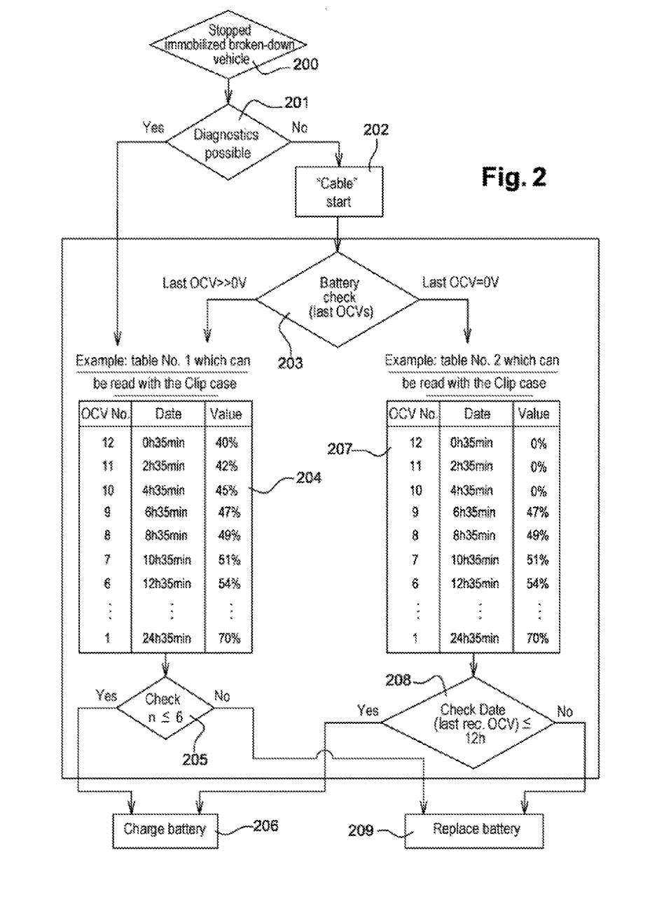

FIG. 2 schematically represents a flowchart for another method for monitoring an electrical battery of a vehicle.

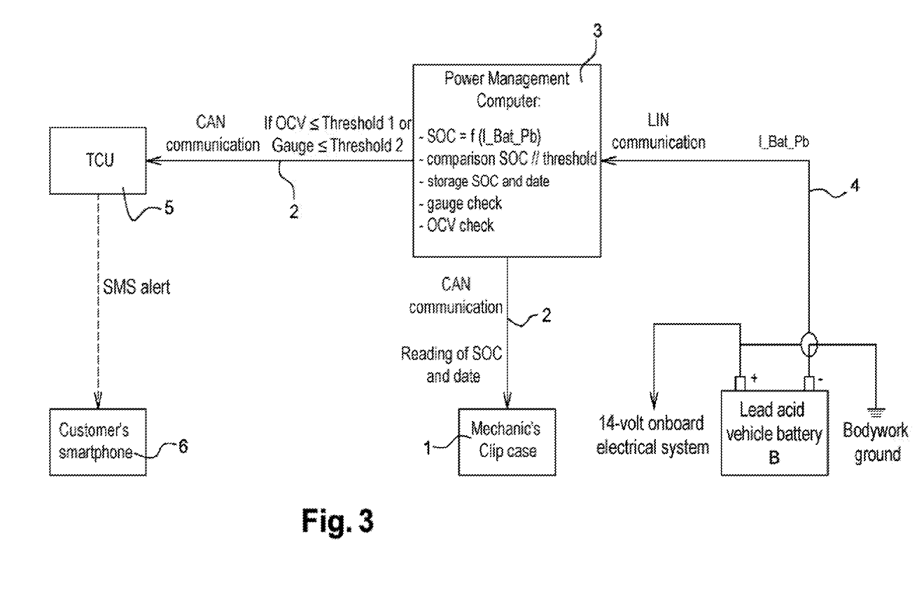

FIG. 3 schematically represents a device for monitoring an electrical battery of a vehicle to implement one of the monitoring methods according to live invention in FIG. 1 or FIG. 2.

In FIG. 1, a method for monitoring an electrical battery of a vehicle starts with a step 100 in which the vehicle is stopped, meaning that the internal combustion engine of the vehicle is stopped.

The method continues at a step 101 for checking the slams of the vehicle, to determine if the vehicle is in “sleep mode” or not.

The status of a vehicle can be described as in “sleep mode” if this vehicle is on standby by having stopped all electrical consumption that may discharge the electrical battery of the vehicle.

If it is found, in step 101, that the vehicle is in sleep mode, the method continues to step 102.

In step 102, the data corresponding to an open circuit voltage OCV is measured, this measured open circuit voltage OCV data being recorded in the electrical power management computer of the vehicle.

In step 102, the open circuit voltage OCV data is also compared to a first predetermined threshold, e.g. in the order of 12 volts.

If the open circuit voltage OCV is greater than said predetermined threshold, the method loops back to the step 101 of checking the status of the vehicle.

If the open circuit voltage OCV is less than said predetermined threshold, we proceed to step 104 of sending an alert to the driver or to the user of the vehicle. The alert can be sent by an SMS text message to the mobile phone or smartphone of the driver or the user or the vehicle.

Any other alert mode can also be considered without departing from the scope of the present invention, such as a voice message, an e-mail message, or any other type of transmission able 10 be received on a receiver of the user or the driver of the vehicle.

If, in step 101, it is found that the vehicle is not in sleep mode, i.e. electrical consumption remains, particularly in the case of an electrical fault, a gauge check is performed in step 103.

The gauge check is measured data that is available in the electrical power management computer of the vehicle. This gauge check corresponds to the state-of-charge of the electrical battery of the vehicle. The gauge check of step 103 allows the data available in the electrical power management computer to be compared to another predetermined threshold, e.g. in the order of 7 volts.

If step 103 determines that the value of the state-of-charge SOC of the battery is less than said predetermined value of said other predetermined threshold, we proceed to step 104 of sending an alert to the driver or to the user of the vehicle.

This step 104 corresponds to sending an alert to a receiver of the driver or user of the vehicle, as described above, by means of an SMS text message or any oilier alert mode, such as a voice message, an e-mail message, or any other type of transmission that may be received on a receiver of the user or the driver of the vehicle.

If the gauge check of step 103 determines that the state-of-charge SOC of the electrical battery of the vehicle is greater than said predetermined value of said other predetermined threshold, the process loops back to step 101 of determining the status of the vehicle.

In FIG. 2, another method for monitoring an electrical battery of a vehicle starts with a step 200 wherein the vehicle is stopped, meaning that its engine is off.

In the case of step 200, the vehicle may be immobilized due to a failure to start, i.e. the internal combustion engine can no longer start independently.

We then proceed to step 201 of checking whether a diagnostic can be performed using a diagnostic set of known type, commonly referred to by specialists as a “Clip case”.

If step 201 leads to finding that the diagnostic is possible using a Clip case, step 204 is performed of reading the internal memory of the electrical power management computer of the vehicle via the Clip case.

In step 204, the diagnostic set reads a predetermined number of recorded values of the state of the battery of the vehicle SOC, e.g. the last twelve values recorded al intervals of approximately two hours.

The reading of the last values recorded by the electrical power management computer allows the recorded values to be compared to a predetermined threshold, e.g. in the order of 12 volts, of the slate-of-charge SOC of the electrical battery.

This comparison is made by extracting the values below this predetermined threshold and recording the number of these values below said predetermined threshold, e.g. in the order of 12 volts.

The number of recorded values below said predetermined values is compared, in step 205, to a predetermined number, e.g. half of the total number of values recorded.

In this example, a check is made to determine if the number of measured values below said predetermined threshold is less than six among the last twelve measured values, recorded in the electrical power management computer. The invention is not limited to the values, thresholds and numbers given by way of non-limiting example, and on the contrary extends to all other numbers, values or thresholds consistent with the verification methodology according to the invention.

If, at step 205, it is found that the number of measured values below the predetermined threshold is less than the fixed predetermined number, we proceed to a battery recharging step 206.

If the number of measured values below said predetermined threshold is greater than said predetermined number, we proceed to a step 209 involving the replacement of the electrical battery with a new battery.

In step 201, if it is found that the diagnostic of the vehicle is not possible using a Clip case, we proceed to a step 202 of starting the vehicle using an external battery, or a starting device by connecting the vehicle to an external battery or other electrical starting means.

After having started the vehicle in step 202, we proceed to a step 203 of checking the electrical battery using the Clip case to verify the values recorded in the electrical power management computer.

The values recorded in step 203 are checked against the open circuit voltage OCV values.

If it is found in step 203 that the last open circuit voltages OCV are significantly greater than zero volts, we proceed to step 204 described above, then to step 205 to be directed to a step 206 or a step 209, as described above.

If the check in step 203 determines that the last open circuit voltages OCV are near to zero volts, we proceed to a step 207 of reading the data recorded in the electrical power management computer.

in step 207, the diagnostic set reads a predetermined number of recorded values of the state of the battery of the vehicle SOC, e.g. the last twelve values recorded at intervals of approximately two hours.

The check of the step 205 allows the date of the last open circuit voltage OCV recording to be compared with a predetermined threshold, e.g. twelve hours.

If the check of the step 205 makes it possible to determine that the date of the last open circuit voltage OCV recording is less than a predetermined date, for example is less than 12 hours, we proceed to a battery charging step 206.

If the check in the step 205 shows that the date of the last open circuit voltage OCV recording is greater than a predetermined date, e.g. greater than twelve boors, we proceed to the step 209 of replacing the battery with a new battery.

In FIG. 3, an electrical battery monitoring device according to the invention comprises a Clip case of a mechanic or a diagnostic set 1.

The diagnostic set 1 is connected via a CAN communication bus 2 to an electrical power management computer 3.

The data passing through the part of the CAN communication bus 2 are mainly time data and read data of measured electrical battery state-of-charge or electrical battery open circuit voltage values.

The electrical power management computer 3 communicates with the battery B of the vehicle by a LIN communication bus.

This UK communication bus 4 allows the electrical power management computer 3 to record the state-of-charge SOC of the electrical battery as a result of a function of the current delivered by the electrical battery B.

The electrical power management computer 3 also allows the state-of-charge SOC of the electrical battery to be compared to a predetermined threshold, arbitrarily chosen, in order to implement the method described in reference to FIG. 1 or the method described in reference in FIG. 2.

The states-of-charge SOC of the electrical battery are stored or recorded in the power management computer by means of a sliding time window enabling the measured and recorded values to be ranked by measurement dates in the electrical power management computer 3.

The values corresponding to the gauge check, and to the open circuit voltage OCV check are recorded or stored in the electrical power management computer 3.

The electrical power management computer 3 is also connected via the CAN communication bus 2 to a telecommunication and control unit 5 able to deliver a wireless message or alert to a user or a vehicle driver having a receiving unit 6, e.g. a portable device, a smartphone or mobile phone.

The communication between the electrical power management computer 3 by the CAN communication bus 2 with the telecommunication and control unit 5 is made to implement the method according to the invention described in reference to FIG. 1 in the case where the open circuit voltage OCV is lower than a predetermined threshold or if the gauge check reveals a value lower than another predetermined threshold.

The invention described in reference to specific embodiments is in no way limited to the latter, but, on the contrary, covers any design amendments and any alternative embodiments within the scope and spirit of the appended claims.

1-10. (canceled)

11. A method for monitoring an electrical battery of a vehicle, comprising consecutive steps of:
measuring a state-of-charge of the electrical battery at predetermined intervals;
comparing the measured values of the state-of-charge of the electrical battery with a first predetermined threshold; and
comparing a number of the measured values below said predetermined threshold to a predetermined number, in order to decide whether to replace or recharge the electrical battery, in order to avoid or remedy an immobilization of the vehicle.

12. The method as claimed in claim 11, further comprising determining a status of the vehicle to determine if the vehicle is electrically asleep or not.

13. The method as claimed in claim 11, further comprising sending an alert, including at least one of an e-mail, a text message, and any other type of warning message, to a driver or user of the vehicle.

14. The method as claimed in claim 11, further comprising determining whether a diagnostic can be performed on the electrical battery of the vehicle using a diagnostic set.

15. The method as claimed in claim 14, further comprising determining and testing last open circuit voltage values of the electrical battery to know whether or not the last open circuit voltage values are significantly higher than zero volts.

16. The method as claimed in claim 14, further comprising controlling a date of last recordings of the state-of-charge of the electrical battery under no load, in order to determine if the electrical battery should be charged or if the electrical battery should be replaced with a new battery.

17. The method as claimed in claim 14, further comprising controlling a number of steps in which recorded measured values of the state-of-charge of the electrical battery are less than a predetermined number, in order to decide if the electrical battery should be charged or if the electrical battery should be replaced with a new battery.

18. A device for implementing the method as claimed in claim 11, the device comprising:
means for measuring the state-of-charge of the electrical battery at predetermined intervals;
means for comparing the recorded measured values of the state-of-charge of the electrical battery with a predetermined threshold; and
means for comparing a number of stored measured values below said predetermined threshold to a predetermined number, in order to decide whether to replace or recharge the electrical battery, in order to avoid or remedy an immobilization of the vehicle.

19. The device as claimed in claim 18, further comprising a CAN communication bus configured to be connected to a diagnostic set and to a telecommunication control unit, said telecommunication control unit being configured to issue an alert to a receiver of a driver or vehicle user.

20. The device as claimed in claim 18, further comprising a LIN communication bus connecting an electrical power management computer to an electrical battery of a vehicle.
